(19) United States
(12) Patent Application Publication
(10) Pub. No.: US 2021/0222695 A1
(43) Pub. Date: Jul. 22, 2021

(54) BATTERY POWERED AIR MOVER

(71) Applicant: Intertex, Inc., Azusa, CA (US)

(72) Inventor: Edward Demirdjian, Azusa, CA (US)

(21) Appl. No.: 16/099,171

(22) PCT Filed: May 11, 2018
(86) PCT No.: PCT/US2018/032288

§ 371 Date: Nov. 5, 2018

Related U.S. Application Data
(60) Provisional application No. 62/505,037, filed on May 11, 2017.
(60) Provisional application No. 62/669,692, filed on May 10, 2018.

(51) Int. Cl. F04D 25/06; F04D 25/08; F04D 29/28; F04D 29/70

(52) U.S. Cl. CPC F04D 25/0673; F04D 29/701; F04D 29/281; F04D 25/08

(57) ABSTRACT

One feature pertains to an air mover the includes a direct current (DC) electric motor, an impeller operatively coupled to the DC motor, a battery electrically coupled to the DC motor, and a housing that includes the DC electric motor, the impeller, and the battery.

### CLAIM OF PRIORITY

The present application for patent claims priority to U.S. Provisional Application No. 62/505,037 entitled “Battery Powered Air Mover” filed May 11, 2017 and Provisional Application No. 62/669,692 entitled “Battery Powered Air Mover” filed May 10, 2018, the entire disclosures of which are hereby expressly incorporated by reference.

### BACKGROUND

### Field

Various features relate to air movers, and more specifically, to battery powered air movers.

### Background

Large, powerful air movers found in the prior art use alternating current (AC) motors that require an AC mains power supply. This necessitates a corded air mover that must be plugged into an electrical outlet. However, the cords associated with such air movers pose tripping hazards and cause accessibility limitations. For example, liquid may spill out on the dining area floor of a restaurant requiring immediate cleanup to prevent an accidental slip and fall. Mopping up the spill and then using a conventional, corded air mover to dry the area creates an undesirable tripping hazard from the air mover's cord running along the floor of a high traffic eating area.

There is a need for a powerful, battery powered, cordless air mover having sufficient power and air moving capability for many commercial/industrial applications.

### SUMMARY

One feature provides an air mover comprising a direct current (DC) electric motor, an impeller operatively coupled to the DC motor, a battery electrically coupled to the DC motor, and a housing that includes the DC electric motor, the impeller, and the battery. According to one aspect, the air mover further comprises a control interface on a side of the air mover. According to another aspect, the air mover further comprises an inner control housing that houses and secures the battery.

According to one aspect, the control interface covers the inner control housing. According to another aspect, the inner control housing includes a control box that houses electrical components associated with one or more controls on the control interface. According to yet another aspect, the inner control housing includes a slotted, perimeter grille that is configured to allow air to flow around and past the inner control housing and into an interior region of the air mover.

According to one aspect, the control interface includes an ON/OFF switch. According to another aspect, the control interface further includes at least one of an impeller speed control and/or a battery charge meter that indicates an amount of battery charge remaining in the battery. According to yet another aspect, the housing includes an air inlet opening on a first side of the air mover that is configured to draw air into an interior region of the air mover and an air outlet opening that is configured to blow air generated by the impeller out from the air mover.

According to one aspect, the DC electric motor has a nominal input voltage rating of X volts and the battery has a nominal terminal voltage of substantially X volts. According to another aspect, the DC electric motor has a nominal input voltage rating of about 36 volts and the battery has a nominal terminal voltage of about 36 volts. According to yet another aspect, the DC electric motor drives the impeller to generate at least 600 CFM of airflow at the air outlet opening.

According to one aspect, the housing further includes a semi-annular cavity around a cylindrical perimeter of the housing that is adapted to secure the battery, the battery being semi-annular in shape. According to another aspect, the DC electric motor has a nominal input voltage rating of X volts and the battery has a nominal terminal voltage of 0.50X to 0.75X volts. According to yet another aspect, the DC electric motor has a nominal input voltage rating of 54 volts and the battery has a nominal terminal voltage of 36 volts.

### BRIEF DESCRIPTION OF THE DRAWINGS

FIG. 1 illustrates a front-perspective view of an air mover.

FIG. 2 illustrates a rear-perspective view of the air mover.

FIG. 3 illustrates a side view of the air mover's first side.

FIG. 4 illustrates a side view of the air mover's second side.

FIG. 5 illustrates an exploded view of the air mover's second side.

FIG. 6 illustrates a side view of the air mover's second side with the control interface removed.

FIG. 7 illustrates an alternative control interface of a battery powered air mover.

FIG. 8 illustrates an exploded view of the air mover.

FIG. 9 illustrates an exploded view of a DC motor removed out from inside of a cylindrical-shell shaped impeller.

FIG. 10 illustrates the DC motor within the impeller.

FIG. 11 illustrates a side view of the DC motor coupled to the impeller.

FIG. 12 illustrates a front view of a second exemplary air mover.

FIG. 13 illustrates a cross-sectional view of the second exemplary air mover.

FIG. 14 illustrates a curved, semi-annular battery residing within a battery cavity.

FIG. 15 illustrates a schematic block diagram of a battery charging system.

### DETAILED DESCRIPTION

In the following description, specific details are given to provide a thorough understanding of the various aspects of the disclosure. However, it will be understood by one of ordinary skill in the art that the embodiments may be practiced without these specific details. The word “exemplary” is used herein to mean “serving as an example, instance, or illustration.” Any implementation or embodiment described herein as “exemplary” is not necessarily to be construed as preferred or advantageous over other aspects of the disclosure. Likewise, the term “embodiments” does not require that all embodiments of the disclosure include the discussed feature, advantage or mode of operation.

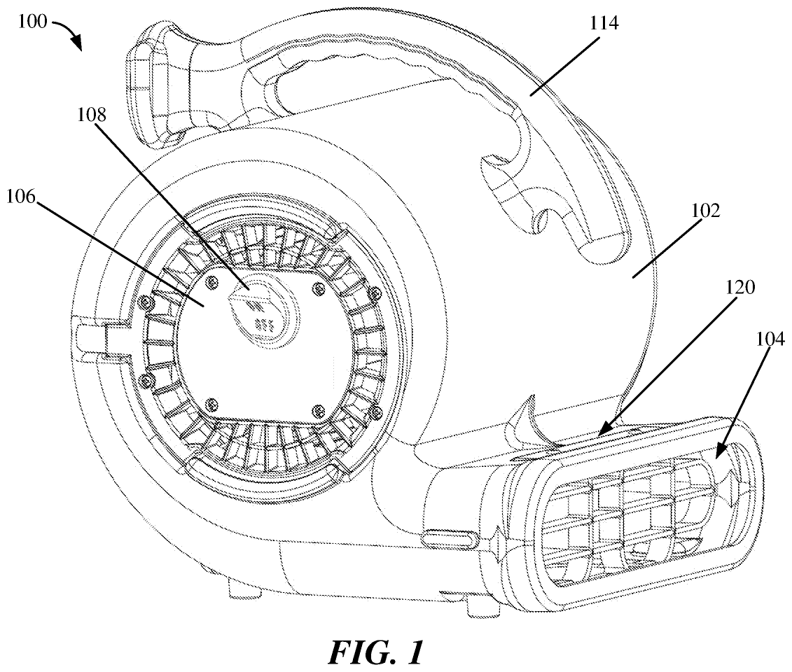

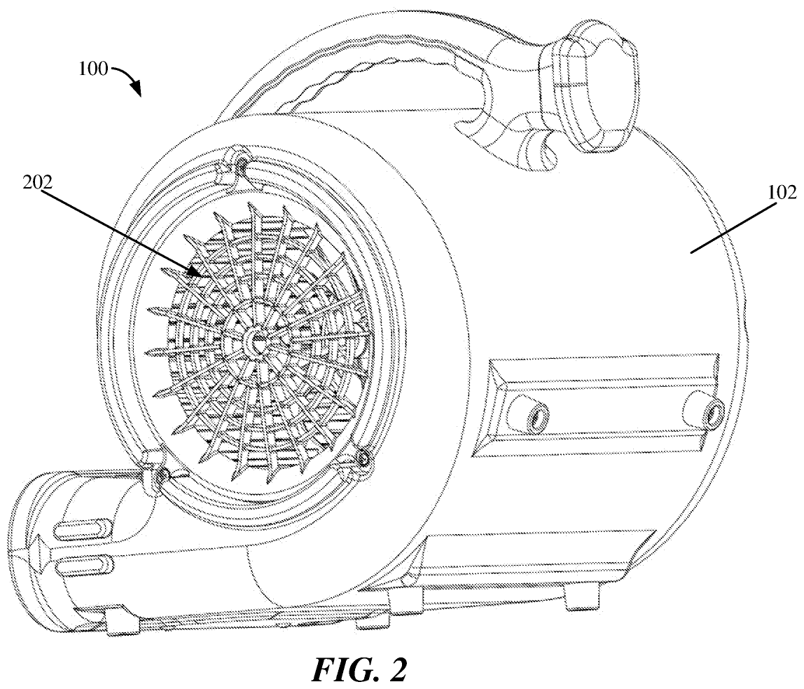

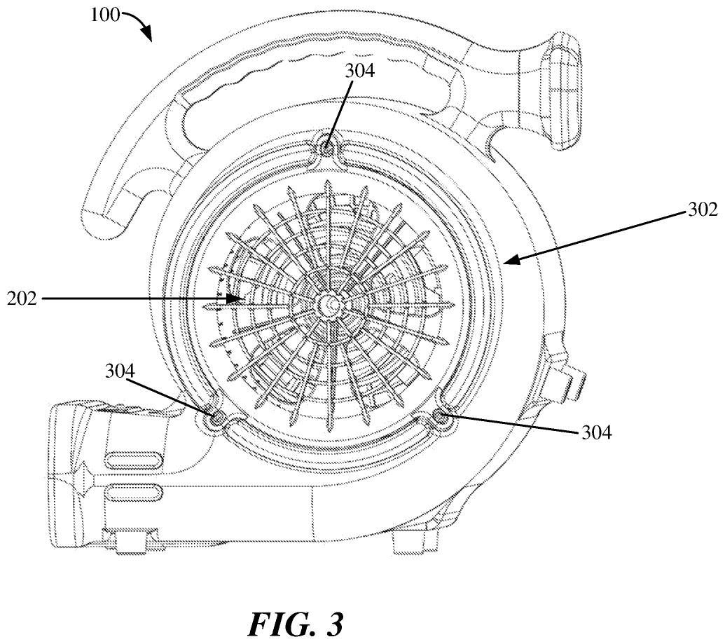

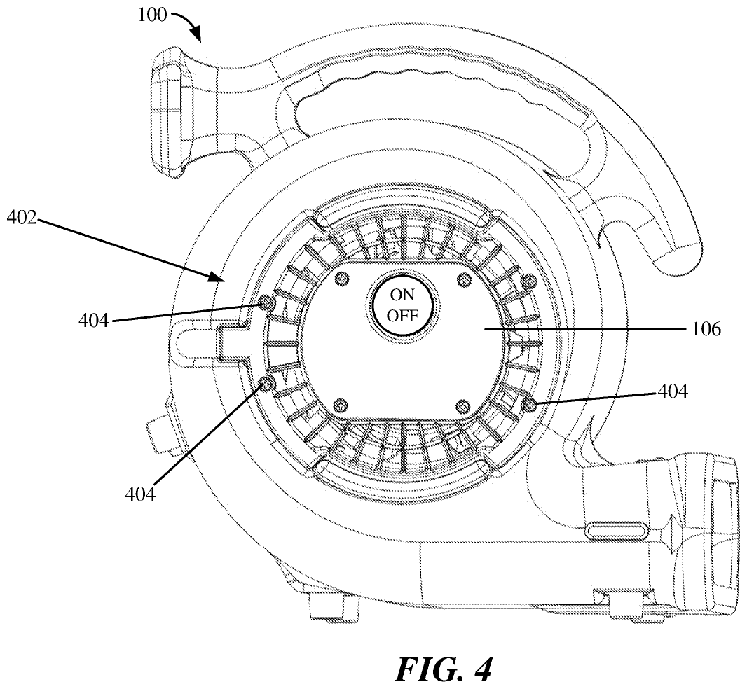

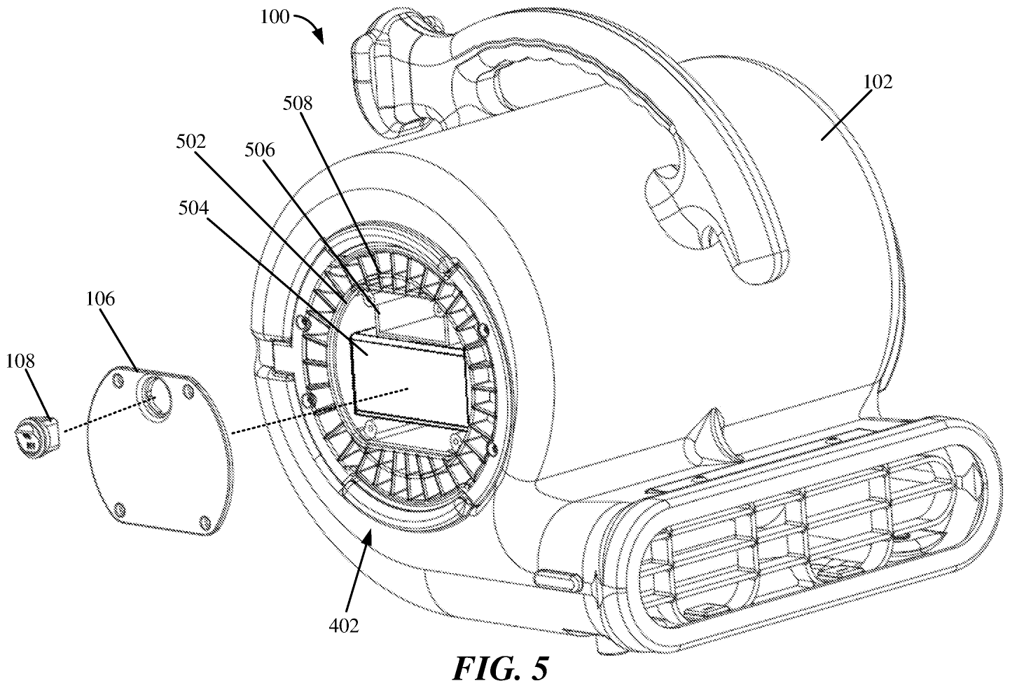

FIGS. 1-5 illustrate an air mover 100 (e.g., air blower, fan, dryer, etc.) according to one aspect of the present disclosure. Specifically, FIG. 1 illustrates a front-perspective view, FIG. 2 illustrates a rear-perspective view, FIG. 3 illustrates a first side view, FIG. 4 illustrates a second side view, and FIG. 5 illustrates an exploded view of the air mover 100. The air mover 100 is a cordless, battery powered unit that features performance rivaling, if not exceeding, mains electricity (e.g., wire-line alternating current (AC)) powered air movers of similar size.

Referring to FIGS. 1 and 2, the air mover 100 includes a housing 102 that has an air inlet opening 202 and an air outlet opening 104. The housing 102 may have a general “snail” shape. Within the housing 102 is secured, among other things, a battery-powered motor that drives an impeller that causes ambient air outside the air mover 100 to be drawn in through the inlet opening 202 and forced out the outlet opening 104 at high speed. The air mover 100 also includes a control interface 106 that may include a plurality of buttons and/or controls (e.g., power ON/OFF 108, impeller speed control, etc.), which control operation of the air mover 100. The control interface 106 may also include one or more output devices such as a battery charge level indicator that indicates the amount of charge left (e.g., percentage remaining) in the battery of the air mover 100. The housing 102 may also include one or more handles 114 to help lift and transport the air mover 100. According to one aspect, the housing 102 may be manufactured using a rotational molding (rotomolding) process. In other aspects, it may be manufactured using different processes such as injection molding, thermo-forming, or blow molding.

FIG. 3 illustrates a first side 302 of the air mover 100 according to one aspect. The first side 302 includes the inlet opening 202.

FIG. 4 illustrates a second side 402, opposite the first side 302, of the air mover 100 according to one aspect. The second side 402 includes the control interface 106.

FIG. 5 illustrates an exploded, perspective view of the air mover's second side 402 according to one aspect. The air mover 100 may include an inner control housing 502 that receives and secures a battery 504. The inner control housing 502 may also include a control box 506 that houses electrical components associated with control interface's 106 various buttons and/or switches 108. The control interface 106 may be secured to the inner control housing 502 using fasteners (not shown) and serve as a cover to the battery 504 and control box 506. The inner control housing 502 may also include a slotted, perimeter grille 508 that allows air to flow around and past the inner control housing 502 and into the air mover's housing 102.

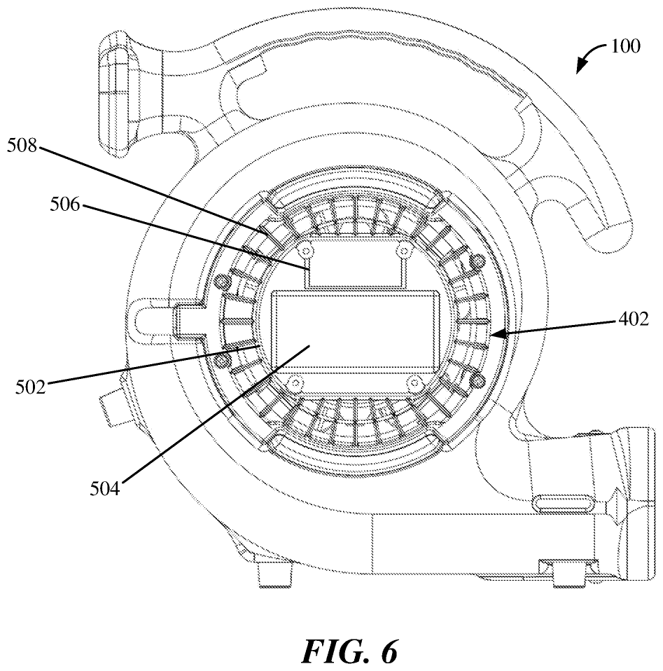

FIG. 6 illustrates a side view of the air mover's second side 402 with the control interface 106 removed according to one aspect.

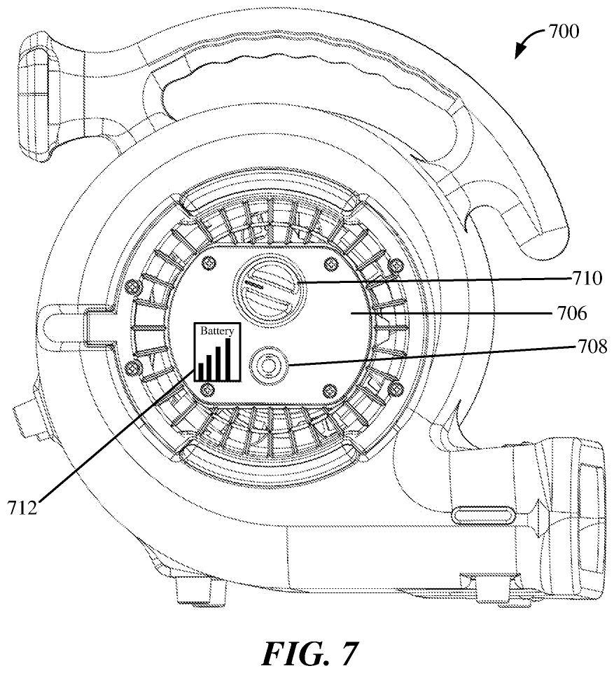

FIG. 7 illustrates an alternative control interface 706 of a battery powered air mover 700 according to one aspect. In the example shown, the control interface 706 includes an ON/OFF switch 708, an impeller speed control 710, and a battery charge meter 712. The impeller speed control 710 allows a user to change the speed of the impeller within the air mover 700 thereby controlling the amount of air flowing out of the air mover 700. The battery charge meter 700 may indicate the amount of charge left (e.g., percentage remaining) in the battery 504 of the air mover 100.

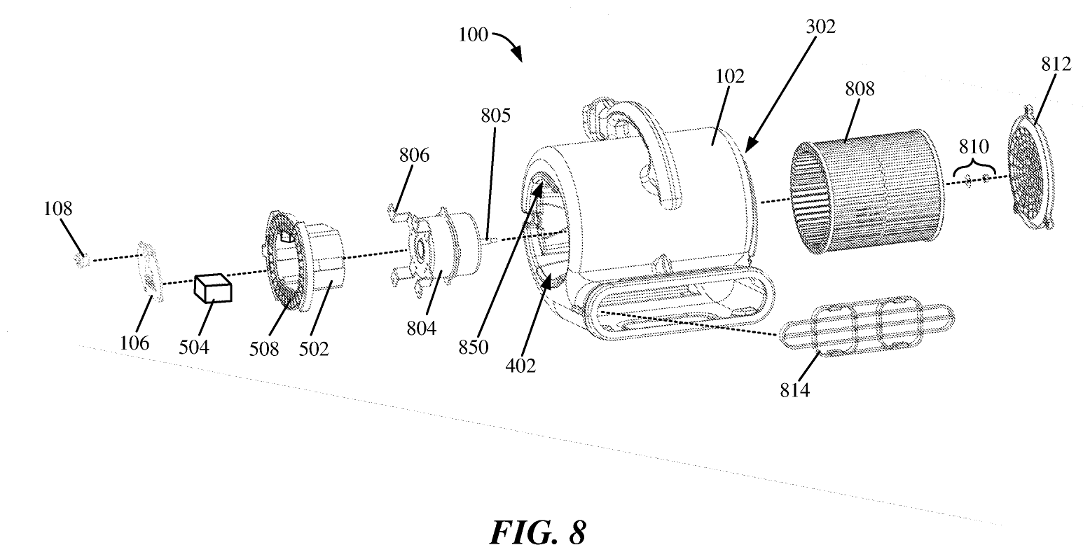

FIG. 8 illustrates an exploded view of the air mover 100 according to one aspect. The air mover 100 also includes a direct current (DC) motor 804 powered by the battery 504. A motor bracket 806 coupled to the DC motor 804 may secure the DC motor 804 to a corresponding motor support within the air mover's housing 102. The DC motor 804 drives an impeller 808 via a motor drive shaft 805. The drive shaft 805 may be coupled to the impeller 808 using a fastener assembly 810, which may include one or more nuts, bolts, and/or washers. An inlet opening grille 812 covers the inlet opening 202 (see FIG. 2) and secures to the first side 302 of the air mover 100. An outlet opening grille 814 may cover the air outlet opening 104.

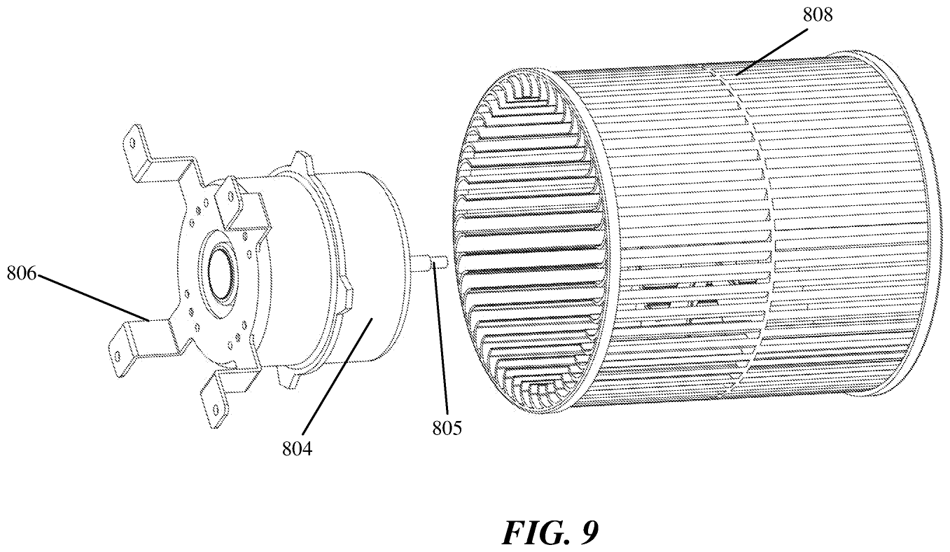

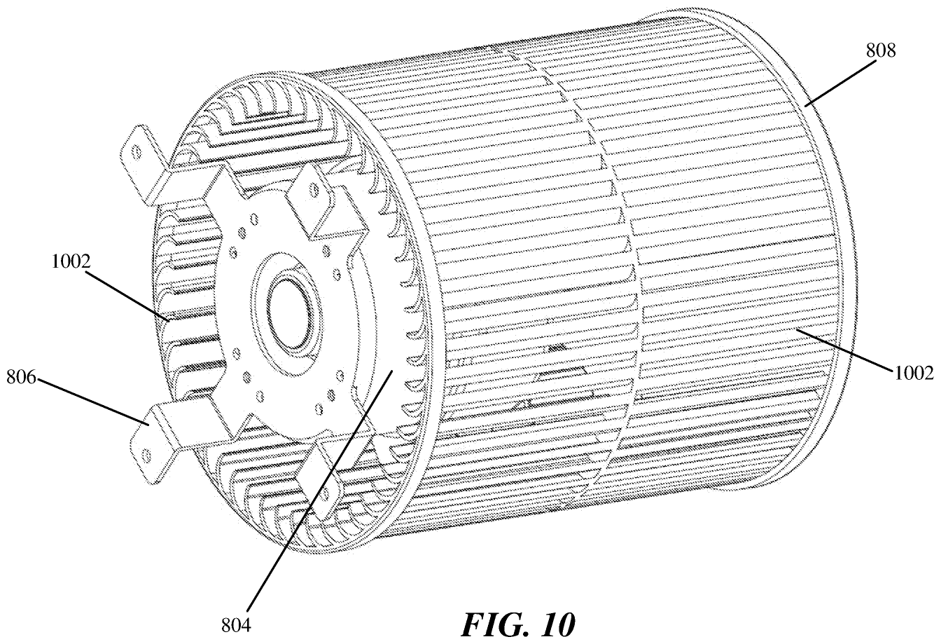

FIG. 9 illustrates an exploded view of the DC motor 804 removed out from inside of the cylindrical-shell shaped impeller 808 that houses the DC motor 804. FIG. 10 illustrates how the DC motor 804 fits within the impeller 808 so that the impeller 808 substantially surrounds the DC motor 804. The DC motor 804 drives the impeller 808 through its motor drive shaft 805 causing the impeller 808 to spin rapidly. The impeller's fins 1002 generate large amounts of airflow that flow out from the air mover's outlet opening 104 (see FIG. 1). As the impeller 808 rotates about its central rotation axis (e.g., longitudinal axis of the drive shaft 808) the air flow generated by the myriad of impeller fins 1002 may also help cool the DC motor 804.

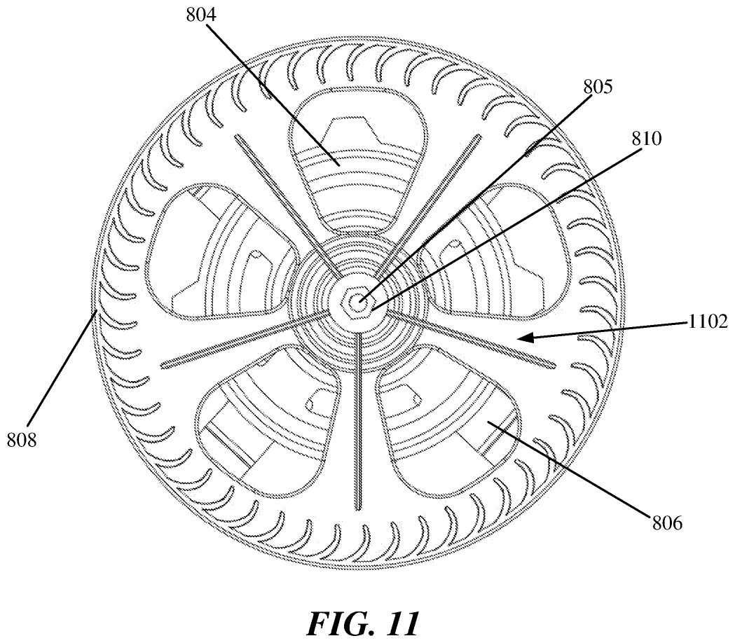

FIG. 11 illustrates a side view of the DC motor 804 coupled to the impeller 808 according to one aspect. The end of the drive shaft 805 may be threaded and may pass through a corresponding aperture in the middle of the impeller's side surface 1102. The fastener assembly (e.g., nut and washer) 810 may secure the threaded end of the drive shaft 805 to the impeller's side surface 1102 so that the impeller 808 and the drive shaft 805 are operatively coupled. That is, as the drive shaft 805 of the DC motor 804 rotates so too does the impeller 808.

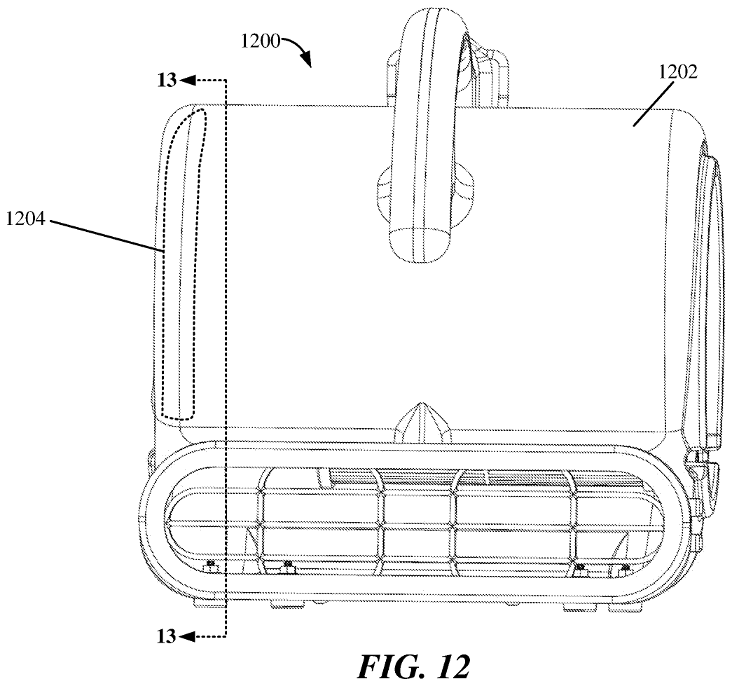

FIG. 12 illustrates a front view of an air mover 1200 according to one aspect of the disclosure. As indicated by the dashed line, a battery 1204 may reside within the housing 1202 that powers the air mover's DC motor.

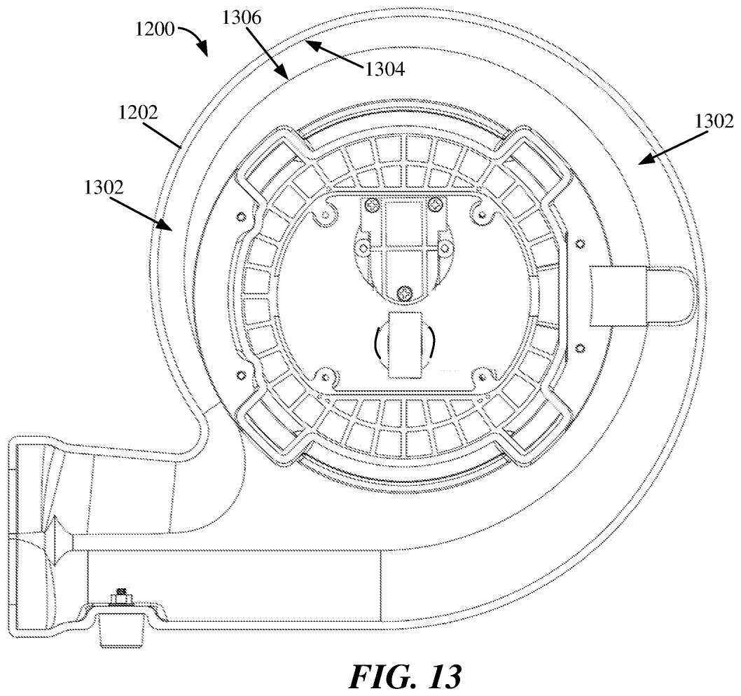

FIG. 13 illustrates a cross-sectional view of the air mover 1200 taken along the line 13-13 of FIG. 12 according to one aspect. The air mover's housing 1202 may include a circular (e.g., annular) or semi-circular (e.g., semi-annular) battery cavity 1302 bounded between a semi-circular first surface 1304 and a semi-circular second surface 1306. The first surface 1304 may be the interior surface of exterior housing 1202 and the second surface 1306 may be a surface associated with a folded inner portion of the housing 1202 (e.g., similar to folded inner portion 850 shown in FIG. 8). Thus, according to one aspect, the first surface 1304, second surface 1306, and/or the folded inner portion of the housing may define the battery cavity 1302.

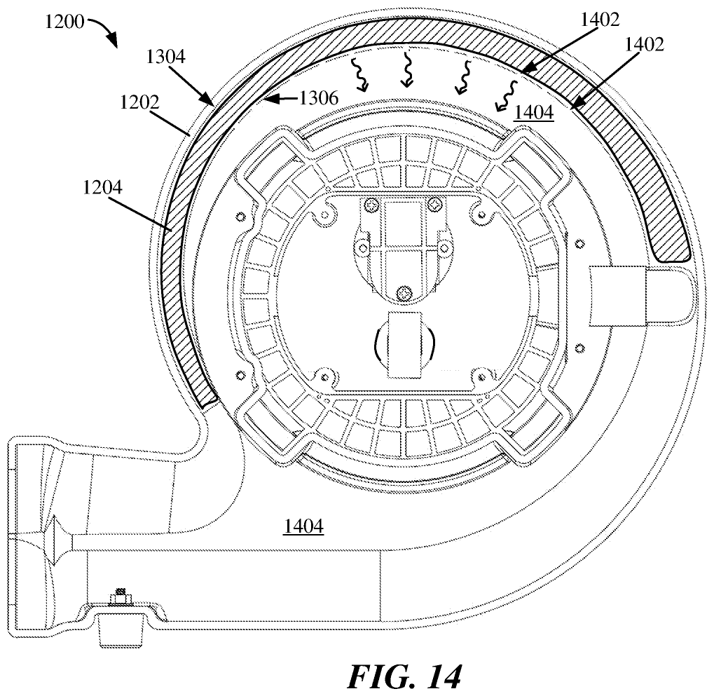

FIG. 14 illustrates how the curved, semi-annular battery 1204 may reside within the battery cavity 1302 according to one aspect. Positioning the battery 1204 in this space may allow the air mover 1200 to remain compact and efficiently utilize space within the air mover 1200 that is otherwise not being used. Moreover, a semi-annular battery 1204 that wraps around or partially around the curved, substantially cylindrically-shaped housing 1202 may distribute the battery's weight more evenly about the air mover 1200, which helps stabilize the air mover 1200. Referring to FIG. 14, the second surface 1306 of the folded inner portion 850 may include openings (e.g., air vents) 1402 to allow heat generated by the battery 1204 to dissipate out and toward the interior portion 1104 of the air mover 100 where it can be swept away by the high speed airflow generated by the impeller 508.

Any one of the batteries 504, 1204 described herein may either be fixed/integrated (i.e., not easily removeably from the air mover 100, 1200) or be readily removable and replaceable. In the latter case, the removable battery 504, 1204 may be removed from the housing 102, 1202 once it has been depleted and may be replaced with a fully charged back-up battery. Placement of the battery is not limited to the locations shown in the figures, and instead the battery may be placed anywhere on or within the air mover's housing 102. The battery 504, 1204 may be non-rechargeable or rechargeable. In the preferred embodiment the battery 504, 1204 is rechargeable. Thus, the battery 504, 1204 may be, for example, lithium-ion, nickel-cadmium (NiCd), nickel-metal hydride (NiMH), lead acid, and/or lithium polymer.

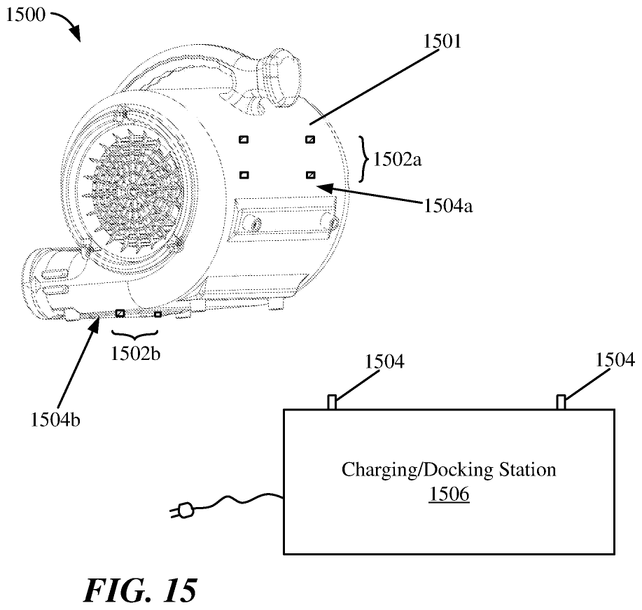

Whether the air mover 100, 1200 features removable or fixed batteries 504, 1204, the air mover 100, 1200 may include charging electrical contacts that allow the air mover's battery 504, 1204 to be charged if placed on a corresponding charging docking station. FIG. 15 illustrates a schematic block diagram of such a charging system 1500. The air mover 1501 may include charging electrical contacts 1502a and/or 1502b, for example, on its backside 1504a and/or underside 1504b that mate with corresponding contacts 1506 located on the charging/docking station 1508. If electrical contacts 1502b are placed on the underside 1504b of the air mover then care may be taken to ensure that the electrical contacts include a water-resistant interface to prevent water from shorting the electrical contacts 1502b during the times where the air mover 1501 is being used in a damp environment (e.g., resting over a puddle of water).

According to one aspect, the DC motor 804 (see FIGS. 8 and 9) may be designed such that it has a nominal input voltage (i.e., an input voltage at which the DC motor 804 has its maximum efficiency) of between 18 volts and 72 volts. In one aspect, the battery 504, 1204 (see FIGS. 5, 6, 12, 14) of the air mover 100, 1200 may have a nominal terminal voltage that substantially matches the nominal input voltage of the DC motor 804 that it powers. For example, if the DC motor 804 has a nominal input voltage rating of 18 volts, 20 volts, 24 volts, 30 volts, 36 volts, 54 volts, or 72 volts, then the battery 504, 1204 may have a nominal terminal voltage of 18 volts, 20 volts, 24 volts, 30 volts, 36 volts, 54 volts, or 72 volts, respectively. According to one aspect, the battery 504, 1204 may have a capacity that ranges from 1.2 Ah to 15.0 Ah. For example, the battery 504, 1204 may have a capacity of 2.4, 3.4, 5.1, or 6.8 Ah.

According to one aspect of the disclosure, the air mover 100, 1200 may include a DC motor 804 having a nominal input voltage of 36 volts and a battery 504, 1204 having a nominal terminal voltage of 36 volts. The battery 504, 1204 may have a working voltage between 25 volts and 42.5 volts where it may shut off if it falls below 25 volts. The battery 504, 1204 may also have a 2.4 amp-hour (Ah) capacity when fully charged providing about 86.4 watt-hours (Wh) of power. The DC motor 804 may draw about 2.2 amps of current. The amount of current drawn by the DC motor 804 may increase slightly as the battery 504, 1204 is depleted. For example, the DC motor 804 may draw 2.2 amps of current during its first 30 minutes of operation, about 2.3 amps during the next 20 minutes of operation, and then about 2.45 amps the next 25 minutes of operation. Thus, according to one aspect, the air mover 100, 1200 may continuously operate on a single battery charge for at least 75 minutes. Such a configuration also allows the air mover 100, 1200 to provide out from its air outlet opening: a peak air volume of about 650 cubic feet per minute (CFM), a nominal air volume of 470 CFM, and an air speed of up to 12.6 meters per second (m/s). The air mover's impeller 808 may rotate at about 1,250 revolutions per minute (RPM). The air mover 100, 1200 may have a generally compact size having a length, width, and height of about 12.8″, 12.4″, and 13.3″, respectively, and weighs about 9.5 lbs. The aforementioned performance values and dimensions are merely exemplary and the air mover may be designed to have performance values and/or dimensions that are less or greater than those listed.

According to another aspect, the air mover's battery 504, 1204 may have a nominal terminal voltage that is substantially different than the nominal input voltage of the DC motor 804 that it powers. For example, the battery's 504, 1204 nominal terminal voltage may be between 50% to 75% of the nominal input voltage rating of the DC motor 804. Despite operating at an input voltage lower than its maximum rated efficiency, the DC motor 804 may unexpectedly drive the impeller 808 for a longer duration of time than if paired with a battery matching its nominal input voltage.

For example, based on experimental observations, the air mover 100 was equipped and operated with a 54 volt nominal input voltage DC motor 804 that was powered by a 36 volt rechargeable battery 504 having a 3.4 Ah capacity. In such a case the air mover 100 produced the following results:

| Time Elapsed | Air Flow Measured at Outlet Opening 104 |
|---|---|
| 0 min | 3200 feet per minute (FPM) |
| 15 min | 3000 feet per minute (FPM) |
| 30 min | 2850 feet per minute (FPM) |
| 45 min | 2750 feet per minute (FPM) |
| 60 min | 2570 feet per minute (FPM) |
| 75 min | 2250 feet per minute (FPM) |

One or more of the components, steps, features, and/or functions illustrated in FIGS. 1, 2, 3, 4, 5, 6, 7, 8, 9, 10, 11, 12, 13, 14, and/or 15 may be rearranged and/or combined into a single component, step, feature or function or embodied in several components, steps, or functions. Additional elements, components, steps, and/or functions may also be added without departing from the invention.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. An air mover comprising:
a direct current (DC) electric motor;
an impeller operatively coupled to the DC motor;
a battery electrically coupled to the DC motor; and
a housing that includes the DC electric motor, the impeller, and the battery.

2. The air mover of claim 1, wherein the air mover further comprises:
a control interface on a side of the air mover.

3. The air mover of claim 2, wherein the air mover further comprises:
an inner control housing that houses and secures the battery.

4. The air mover of claim 3, wherein the control interface covers the inner control housing.

5. The air mover of claim 3, wherein the inner control housing includes a control box that houses electrical components associated with one or more controls on the control interface.

6. The air mover of claim 4, wherein the inner control housing includes a slotted, perimeter grille that is configured to allow air to flow around and past the inner control housing and into an interior region of the air mover.

7. The air mover of claim 6, wherein the control interface includes an ON/OFF switch.

8. The air mover of claim 7, wherein the control interface further includes at least one of an impeller speed control and/or a battery charge meter that indicates an amount of battery charge remaining in the battery.

9. The air mover of claim 1, wherein the housing includes an air inlet opening on a first side of the air mover that is configured to draw air into an interior region of the air mover and an air outlet opening that is configured to blow air generated by the impeller out from the air mover.

10. The air mover of claim 9, wherein the DC electric motor has a nominal input voltage rating of X volts and the battery has a nominal terminal voltage of substantially X volts.

11. The air mover of claim 10, wherein the DC electric motor has a nominal input voltage rating of about 36 volts and the battery has a nominal terminal voltage of about 36 volts.

12. The air mover of claim 11, wherein the DC electric motor drives the impeller to generate at least 600 CFM of airflow at the air outlet opening.

13. The air mover of claim 1, wherein the housing further includes a semi-annular cavity around a cylindrical perimeter of the housing that is adapted to secure the battery, the battery being semi-annular in shape.

14. The air mover of claim 1, wherein the DC electric motor has a nominal input voltage rating of X volts and the battery has a nominal terminal voltage of 0.50X to 0.75X volts.

15. The air mover of claim 1, wherein the DC electric motor has a nominal input voltage rating of 54 volts and the battery has a nominal terminal voltage of 36 volts.
